(19) United States
(12) Patent Application Publication
(10) Pub. No.: US 2026/0245331 A1
(43) Pub. Date: Aug. 20, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Tomokazu KANEKO, Tokyo (JP); Soma SHIRAISHI, Tokyo (JP); Ryosuke SAKAI, Tokyo (JP); Ryo NAKAO, Tokyo (JP)

(73) Assignee: NEC Corporation, Tokyo (JP)

(21) Appl. No.: 19/449,566

(22) Filed: Jan. 15, 2026

(30) Foreign Application Priority Data
Feb. 17, 2025 (JP) 2025-023697

(51) Int. Cl. G06V 10/25

(52) U.S. Cl. CPC G06V 10/25; G06V 2201/07

(57) ABSTRACT

An information processing apparatus includes, one or more memories storing instructions, and one or more processors configured to execute the instructions to, extract an object representation of each of objects included in a target image, generate one or a plurality of first regions of interest based on the object representation, generate a prompt based on the first region of interest, generate one or a plurality of second regions of interest from the target image and the prompt using a pre-trained model, calculate a loss with reference to the first region of interest and the second region of interest, and train the extraction model with reference to the loss.

### CROSS-REFERENCE TO RELATED APPLICATIONS

This application is based upon and claims the benefit of priority from Japanese Patent Application No. 2025-023697, filed on February 17, 2025, the disclosure of which is incorporated herein in its entirety by reference.

### TECHNICAL FIELD

The present disclosure relates to an information processing apparatus, an information processing method, and a recording medium.

### BACKGROUND ART

There is known a technique of detecting an object from a target image. For example, WO 2024/180647 A1 discloses a training device that includes an object representation extraction unit and trains a model for extracting an object representation.

### SUMMARY

However, according to existing techniques as described above, the model for extracting an object representation obtains the object representation by self-supervised learning, which involves a problem that accuracy in dividing a region of interest in an object image is low.

The present disclosure has been conceived in view of the problem described above, and an exemplary object thereof is to provide a technique capable of efficiently training a high-precision model for extracting an object.

An information processing apparatus according to an exemplary aspect of the present disclosure includes a first generation means for extracting an object representation of each of objects included in a target image and generating one or a plurality of first regions of interest based on the object representation, a second generation means for generating a prompt based on the first region of interest and generating one or a plurality of second regions of interest from the target image and the prompt using a pre-trained model, a loss calculation means for calculating a loss with reference to the first region of interest and the second region of interest, and a training means for training the first generation means with reference to the loss.

An information processing method according to an exemplary aspect of the present disclosure causes one or a plurality of processors to perform processing of extracting an object representation of each object included in a target image using an extraction model and generating one or a plurality of first regions of interest based on the object representation, generating a prompt based on the first region of interest and generating one or a plurality of second regions of interest from the target image and the prompt using a pre-trained model, calculating a loss with reference to the first region of interest and the second region of interest, and training the extraction model with reference to the loss.

An information processing program according to an exemplary aspect of the present disclosure causes a computer to function as an information processing apparatus, the program causing the computer to function as a first generation means for extracting an object representation of each object included in a target image and generating one or a plurality of first regions of interest based on the object representation, a second generation means for generating a prompt based on the first region of interest and generating one or a plurality of second regions of interest from the target image and the prompt using a pre-trained model, a loss calculation means for calculating a loss with reference to the first region of interest and the second region of interest, and a training means for training the first generation means with reference to the loss.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a diagram for explaining an exemplary process in the information processing system according to the present disclosure;

FIG. 5 is a diagram for explaining a processing flow in the information processing system according to the present disclosure;

FIG. 6 is a diagram for explaining an exemplary configuration and an exemplary process in the information processing system according to the present disclosure;

FIG. 7 is a diagram for explaining an exemplary configuration and an exemplary process in the information processing system according to the present disclosure;

FIG. 8 is a diagram for explaining an exemplary configuration and an exemplary process in the information processing system according to the present disclosure;

FIG. 9 is a block diagram illustrating a configuration of the information processing system according to the present disclosure; and

FIG. 10 is a block diagram illustrating a configuration of a computer that functions as the information processing apparatus according to the present disclosure.

### EXAMPLE EMBODIMENT

Hereinafter, example embodiments of the present disclosure will be exemplified. However, the present disclosure is not limited to the following illustrative example embodiments, and various modifications may be made within the scope described in the claims. For example, example embodiments obtained by appropriately combining techniques (some or all of objects or methods) adopted in the following illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are exemplary effects expected in the illustrative example embodiments, and do not define the extension of the present disclosure. That is, example embodiments that do not exert the effects mentioned in the following illustrative example embodiments may also fall within the scope of the present disclosure.

### First Example Embodiment

A first illustrative example embodiment, which is an example of the example embodiments of the present disclosure, will be described in detail with reference to the drawings. The present illustrative example embodiment is a basic form of the example embodiments to be described later. An application range of each technique adopted in the present illustrative example embodiment is not limited to the present illustrative example embodiment. That is, each technique adopted in the present illustrative example embodiment may also be adopted in another illustrative example embodiment included in the present disclosure as long as no particular technical problem is raised. Each technique illustrated in the drawings referred to for describing the present illustrative example embodiment may also be adopted in another illustrative example embodiment included in the present disclosure as long as no particular technical problem is raised.

### Configuration of Information Processing Apparatus 1

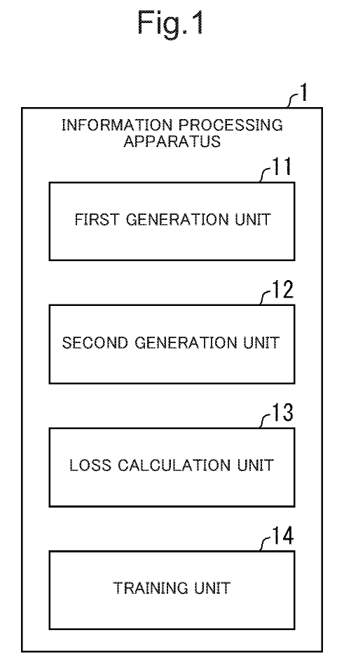

A configuration of an information processing apparatus 1 according to the present illustrative example embodiment will be described with reference to FIG. 1. FIG. 1 is a block diagram illustrating the configuration of the information processing apparatus 1. As illustrated in FIG. 1, the information processing apparatus 1 includes a first generation unit 11, a second generation unit 12, a loss calculation unit 13, and a training unit 14.

### First Generation Unit 11

The first generation unit 11 obtains a target image, extracts an object representation of each object included in the target image, and generates one or a plurality of first regions of interest based on the object representation. Here, the object representation refers to a numerical representation of each object included in the target image, and is expressed as a vector, for example. For example, the object representation is derived with reference to a feature map obtained from the target image. The first region of interest is information generated with reference to the object representation, and is expressed as one or a plurality of first region of interest maps, for example.

While the first generation unit 11 may include, for example, an encoder to which the target image is input and an extraction model that extracts the object representation of each object with reference to an output of the encoder, this configuration does not limit the present illustrative example embodiment.

### Second Generation Unit 12

The second generation unit 12 generates a prompt based on the first region of interest, and generates, using a pre-trained model, one or a plurality of second regions of interest from the target image and the prompt. A specific example of the model trained in advance does not limit the present illustrative example embodiment, and for example, a segment anything model (SAM) may be used.

### Loss Calculation Unit 13

The loss calculation unit 13 calculates a loss with reference to the first region of interest and the second region of interest. A specific example of a loss function referred to by the loss calculation unit 13 does not limit the present illustrative example embodiment, and for example, a loss function configured in such a way that a value of the loss is made smaller as a degree of difference between the first region of interest and the second region of interest is smaller may be used.

### Training Unit 14

The training unit 14 trains the first generation unit 11 with reference to the loss calculated by the loss calculation unit 13. For example, the training unit 14 updates parameters of the extraction model, which is used by the first generation unit 11 and is used to extract the object representation of each object included in the target image, with reference to the loss calculated by the loss calculation unit 13.

### Effects of Information Processing Apparatus 1

As described above, the information processing apparatus 1 includes the first generation unit 11 for extracting the object representation of each object included in the target image and generating one or a plurality of first regions of interest based on the object representation, the second generation unit 12 for generating a prompt based on the first region of interest and generating one or a plurality of second regions of interest from the target image and the prompt using the pre-trained model, the loss calculation unit 13 for calculating the loss with reference to the first region of interest and the second region of interest, and the training unit 14 for training the first generation unit with reference to the loss. As described above, the information processing apparatus 1 generates the first region of interest using the first generation unit 11, generates the second region of interest from the target image and the prompt generated based on the first region of interest, calculates the loss with reference to those regions of interest, and trains the first generation unit 11 with reference to the calculated loss.

Thus, according to the configuration described above, it becomes possible to efficiently generate a high-precision model by dividing the second region of interest highly accurately and training a model for extracting the object representation.

### Flow of Information Processing Method S1

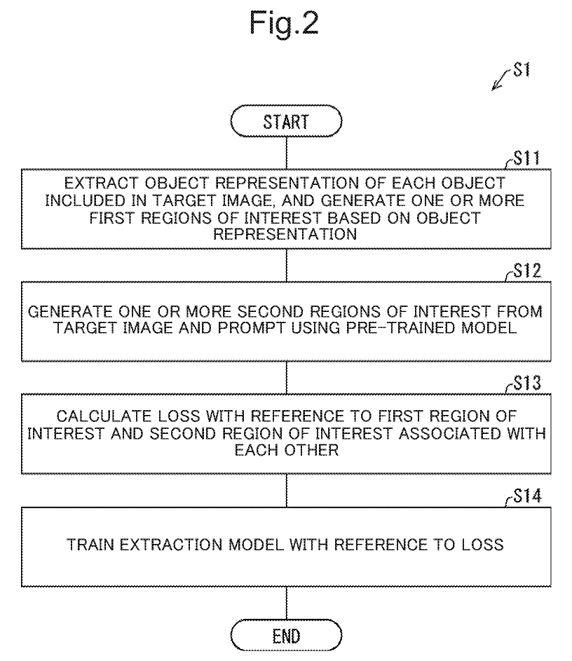

A flow of an information processing method S1 will be described with reference to FIG. 2. FIG. 2 is a flowchart illustrating the flow of the information processing method S1. As illustrated in FIG. 2, the information processing method S1 includes step (processing) S11 for generating the first region of interest, step (processing) S12 for generating the second region of interest, step (processing) S13 for calculating the loss, and step (processing) S14 for training the extraction model.

### Step S11

In step S11, the first generation unit 11 obtains the target image, extracts the object representation of each object included in the target image using the extraction model, and generates one or a plurality of the first regions of interest based on the object representation. The first generation unit 11 has been more specifically described above, and thus descriptions thereof will be omitted here.

### Step S12

In step S12, the second generation unit 12 generates one or a plurality of the second regions of interest from the target image and the prompt using the model trained in advance. The second generation unit 12 has been more specifically described above, and thus descriptions thereof will be omitted here.

### Step S13

In step S13, the loss calculation unit 13 calculates the loss with reference to the first region of interest and the second region of interest. The loss calculation unit 13 has been more specifically described above, and thus descriptions thereof will be omitted here.

### Step S14

In step S14, the training unit 14 trains the extraction model with reference to the loss. The training unit 14 has been more specifically described above, and thus descriptions thereof will be omitted here.

### Effects of Information Processing Method S1

As described above, the information processing method S1 adopts the configuration of extracting the object representation of each object included in the target image using the extraction model and generating one or a plurality of first regions of interest based on the object representation, generating a prompt based on the first region of interest and generating one or a plurality of second regions of interest from the target image and the prompt using the pre-trained model, calculating a loss with reference to the first region of interest and the second region of interest, and training the extraction model with reference to the loss. According to the configuration described above, effects similar to those of the information processing apparatus 1 are exerted.

### Second Example Embodiment

A second illustrative example embodiment, which is an example of the example embodiments of the present disclosure, will be described in detail with reference to the drawings. Components having the same functions as the components described in the illustrative example embodiment described above are denoted by the same reference numerals, and descriptions thereof will be omitted as appropriate. An application range of each technique adopted in the present illustrative example embodiment is not limited to the present illustrative example embodiment. That is, each technique adopted in the present illustrative example embodiment may also be adopted in another illustrative example embodiment included in the present disclosure as long as no particular technical problem is raised. Techniques illustrated in the drawings referred to for describing the present illustrative example embodiment may also be adopted in another illustrative example embodiment included in the present disclosure as long as no particular technical problem is raised.

### Configuration of Information Processing System 100A

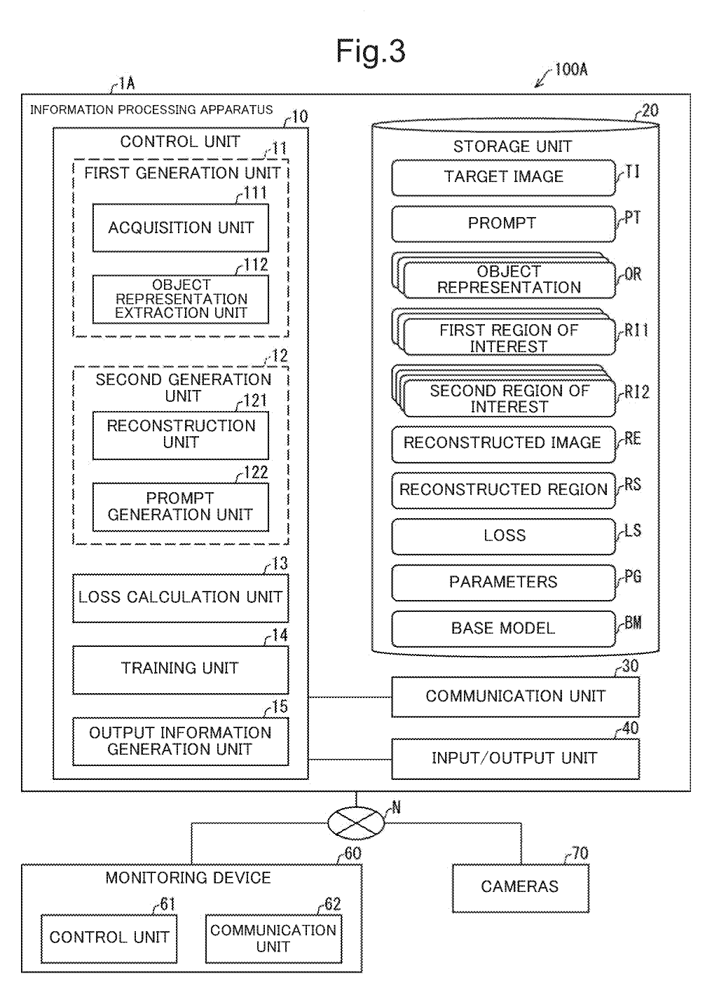

A configuration of an information processing system 100A according to the present illustrative example embodiment will be described with reference to FIG. 3. FIG. 3 is a block diagram illustrating the configuration of the information processing system 100A. As illustrated in FIG. 3, the information processing system 100A includes an information processing apparatus 1A, and a monitoring device 60 and cameras 70 connected to the information processing apparatus 1A via a network N. Here, a specific configuration of the network N does not limit the present illustrative example embodiment, and for example, a wireless local area network (LAN), a wired LAN, a wide area network (WAN), a public line network, a mobile data communication network, or a combination of those networks may be used.

### Cameras 70

The cameras 70 include one or a plurality of cameras. For example, in a case where the monitoring device 60 serves as a traffic monitoring device, those cameras capture images of roads, vehicles, and the like. As another example, in a case where the monitoring device 60 serves as a security monitoring device, those cameras capture images of persons, vehicles, and the like inside or outside a building. The images captured by the cameras 70 are supplied to the information processing apparatus 1A, for example.

### Monitoring Device 60

In general terms, the monitoring device 60 obtains, from the images captured by the cameras 70, a reconstructed image and an object representation extracted by the information processing apparatus 1A, and executes target monitoring processing with reference to the obtained reconstructed image and object representation. As illustrated in FIG. 3, the monitoring device 60 includes a control unit 61 and a communication unit 62. The communication unit 62 receives the object representation and the reconstructed image from the information processing apparatus 1A. Then, the control unit 61 performs traffic monitoring processing with reference to the object representation and reconstructed image obtained from the information processing apparatus 1A. As another example, the control unit 61 performs security monitoring processing in the building with reference to the object representation and reconstructed image obtained from the information processing apparatus 1A.

While the monitoring device 60 has been exemplified as a device separate from the information processing apparatus 1A in the present illustrative example embodiment, this does not limit the present illustrative example embodiment. The function as the control unit 61 included in the monitoring device 60 may be included in the control unit of the information processing apparatus 1A.

### Configuration of Information Processing Apparatus 1A

Next, a configuration of the information processing apparatus 1A according to the present illustrative example embodiment will be described with reference to FIG. 3. As illustrated in FIG. 3, the information processing apparatus 1A includes a control unit 10, a storage unit 20, a communication unit 30, and an input/output unit 40.

### Communication Unit 30

The communication unit 30 communicates with a device outside the information processing apparatus 1A. For example, the communication unit 30 communicates with the cameras 70. The communication unit 30 supplies the images supplied from the cameras 70 to the control unit 10. The communication unit 30 further communicates with the monitoring device 60. The communication unit 30 supplies, to the monitoring device 60, the object representation and reconstructed image derived by the control unit 10.

### Input/Output Unit 40

The input/output unit 40 includes at least one of input/output devices, such as a keyboard, a mouse, a display, a printer, a touch panel, and the like. Alternatively, the input/output unit 40 may be connected to an input/output device, such as a keyboard, a mouse, a display, a printer, a touch panel, or the like. This configuration allows the input/output unit 40 to receive inputs of various types of information from the connected input device to the information processing apparatus 1A. The input/output unit 40 further outputs various types of information to the connected output device under control of the control unit 10. Examples of the input/output unit 40 include an interface, such as a universal serial bus (USB).

### Storage Unit 20

The storage unit 20 stores various types of data to be referred to by the control unit 10, and various types of data generated by the control unit 10. For example, the storage unit 20 stores a target image TI, a prompt PT, an object representation OR, a first region of interest RI1, a second region of interest RI2, a reconstructed image RE, a reconstructed region RS, a loss LS, parameters PG, and a base model BM. For example, the target image TI may or may not be an image supplied from the cameras 70. The target image TI includes at least one of an image (training data) to be used for training processing by the training unit 14 to be described later in a training phase and an image (inference data) to be referred to by an object representation extraction unit 112 to extract the object representation in an inference phase.

The prompt PT is supplementary information, which is generated by a prompt generation unit 122 to be described later and is input to the base model BM. A specific example of the prompt PT will be described later.

The object representation OR is a representation extracted (generated) by the object representation extraction unit 112 to be described later, which is a numerical representation of each object included in the target image TI. The object representation OR is expressed as a vector, for example.

The first region of interest RI1 is information generated by the object representation extraction unit 112 to be described later with reference to the object representation OR, and is expressed as one or a plurality of first region of interest maps, for example. As will be described later, the object representation extraction unit 112 may be implemented using, for example, an attention model or a Slot Attention model. In association with that, the first region of interest RI1 may also be referred to as an attention mask. The attention mask refers to a mask image indicating which region of the target image TI is focused on for representation extraction, and may be implemented as an alpha mask expressed using a coefficient (which is also referred to as an α coefficient) representing multi-level opacity, for example. Meanwhile, the second region of interest RI2 is information generated by a second generation unit 12 to be described later using the base model BM with reference to the target image TI, and is expressed as one or a plurality of second region of interest maps, for example. Specific examples of the first region of interest RI1 and second region of interest RI2 will be described later.

The reconstructed image RE is an image generated by a reconstruction unit 121 to be described later, which is an image reconstructed with reference to the object representation of each object included in the target image TI. The loss LS is calculated by a loss calculation unit 13 to be described later using a loss function. Specific examples of the reconstructed image RE and loss LS will be described later.

The reconstructed region RS is information reconstructed from the object representation OR by the reconstruction unit 121 to be described later, and is expressed as one or a plurality of reconstructed region maps, for example. The reconstruction unit 121 may also be referred to as a decoder 121. In association with that, the reconstructed region map may also be referred to as a decoder mask. The decoder mask refers to a mask image to be used in rendering (reconstruction processing) by the reconstruction unit (decoder) 121, and may be implemented as an alpha mask expressed using a coefficient (which is also referred to as an α coefficient) representing multi-level opacity, for example. The decoder mask has higher resolution and higher precision than those of the first region of interest RI1 (attention mask).

The parameters PG include parameters for defining various models to be used by the control unit 10. For example, the parameters PG include one or a plurality of parameters for defining an encoder to be used by the object representation extraction unit 112, one or a plurality of parameters for defining an extraction model, which is used by the object representation extraction unit 112 and extracts an object representation from an output of the encoder, one or a plurality of parameters for defining a decoder to be used by the reconstruction unit 121, and the like. At least some of those parameters are subject to the training processing (update processing) by the training unit 14 to be described later.

The base model BM is a model trained in advance to be used by the second generation unit 12 to be described later to generate one or a plurality of the second regions of interest RI2 from the target image TI. A specific example of the base model BM does not limit the present illustrative example embodiment, and for example, a segment anything model (SAM) may be used.

### Control Unit 10

As illustrated in FIG. 3, the control unit 10 includes a first generation unit 11, the second generation unit 12, the loss calculation unit 13, the training unit 14, and an output information generation unit 15.

### First Generation Unit 11

The first generation unit 11 obtains the target image TI, extracts the object representation OR of each object included in the target image TI, and generates one or a plurality of the first regions of interest RI1 based on the object representation OR. As illustrated in FIG. 3, the first generation unit 11 includes an acquisition unit 111 and the object representation extraction unit 112.

### Acquisition Unit 111

The acquisition unit 111 obtains the target image TI. The acquisition unit 111 may obtain the target image TI from the above-described cameras 70 via the communication unit 30, or may obtain the target image TI stored in the storage unit 20.

### Object Representation Extraction Unit 112

The object representation extraction unit 112 extracts the object representation OR of each object included in the target image TI.

For example, the object representation extraction unit 112 may include the encoder that receives the target image TI and generates a feature map of the target image TI, and the extraction model for extracting the object representation OR of each object included in the target image TI with reference to the output (feature map) of the encoder. Here, a convolutional neural network (CNN) may be used as the encoder. An attention model, more specifically, a Slot Attention model may be used as the extraction model. However, those examples do not limit the present illustrative example embodiment. The object representation extraction unit 112 may generate the one or plurality of first regions of interest RI1 with reference to the extracted object representation OR. More specifically, the object representation extraction unit 112 may generate one or a plurality of the mask images (attention masks) as one or a plurality of first region of interest maps with reference to one or a plurality of the object representations OR, and may express the one or plurality of first regions of interest RI1 using the attention masks.

### Second Generation Unit 12

The second generation unit 12 generates the one or plurality of second regions of interest RI2 from the target image TI and the prompt PT using the base model BM trained in advance. For example, the second generation unit 12 may generate the one or plurality of second region of interest maps with reference to the target image TI and the prompt PT, and the one or plurality of second regions of interest RI2 may be expressed by the second region of interest maps. The second region of interest (second region of interest map) may be implemented as an alpha mask expressed using a coefficient (which is also referred to as an α coefficient) representing multi-level opacity, for example. As illustrated in FIG. 3, the second generation unit 12 includes the reconstruction unit 121 and the prompt generation unit 122.

### Reconstruction Unit 121

The reconstruction unit 121 reconstructs objects with reference to the object representations of the objects extracted by the object representation extraction unit 112. For example, the reconstruction unit 121 generates the reconstructed images RE including the reconstructed objects. The reconstruction unit 121 may be configured as a decoder that receives the object representations of the objects and outputs the reconstructed images RE. The reconstruction unit 121 may generate one or a plurality of the reconstructed regions RS with reference to the object representations OR. More specifically, the reconstruction unit 121 may generate, as the one or plurality of reconstructed region maps, the mask images (decoder masks) with reference to the one or plurality of object representations OR, and may express the one or plurality of reconstructed regions RS using the decoder masks.

### Prompt Generation Unit 122

The prompt generation unit 122 generates the prompt PT to be input to the base model BM with reference to at least one of the first region of interest RI1 (attention mask) generated by the object representation extraction unit 112 and the reconstructed region RS (reconstructed region map, decoder mask) generated by the reconstruction unit 121. The prompt is a prompt associated with the target image TI. The prompt PT may be a prompt in a predetermined format, or may be a prompt in a format conforming to the target image TI, an input from a user, or the like. The prompt PT generated by the prompt generation unit 122 is input to the base model BM together with the target image TI, and is referred to for generating the one or plurality of second regions of interest RI2.

As more specific examples, the prompt PT may be any of various prompts such as a grid point prompt, a language prompt, a rectangular prompt, a mask prompt, and the like. Here, the grid point prompt refers to a prompt for specifying a target area (point of interest) using one or a plurality of points, the language prompt refers to a prompt for specifying a target area using natural language, the rectangular prompt refers to a prompt for specifying a target area using a rectangle (or coordinate points for specifying the rectangle), and the mask prompt refers to a prompt for specifying a target area using a mask (segmentation mask).

The prompt generation unit 122 may execute sampling processing on an input (attention mask or decoder mask) to the prompt generation unit 122, and may execute prompt shaping processing on a result of the sampling processing. The sampling processing may also be expressed as processing for extracting one or a plurality of points referred to in the prompt shaping processing from the attention mask or the decoder mask. Specific examples of the sampling processing and prompt shaping processing do not limit the present illustrative example embodiment, and some examples are as follows.

### Specific Example of Sampling Processing

Sampling processing according to mask score distribution, more specifically, sampling processing with reference to distribution of mask scores (α coefficients) of the attention mask or decoder mask;

Sampling processing using a threshold for the mask scores, more specifically, processing of extracting one or a plurality of points relevant to scores equal to or more than the threshold among the mask scores (α coefficients) of the attention mask or decoder mask;

Sampling processing using a barycenter of masks, more specifically, processing of calculating a barycenter of a plurality of masks included in the attention mask or decoder mask and extracting one or a plurality of points according to the barycenter;

Sampling processing using Gaussian sampling, more specifically, sampling processing in which the Gaussian sampling is applied to the attention mask or decoder mask;

Sampling processing using negative sampling, more specifically, processing using sampling (negative sampling) that specifies a non-object region in the attention mask or decoder mask;

Sampling processing based on density control, more specifically, sampling processing in which the density control is carried out in such a way that the density of points in the attention mask or decoder mask is made sparse; and Exclusive sampling processing, more specifically, sampling processing in which each target area (each slot) indicated by the attention mask or decoder mask is mutually exclusive.

### Specific Example of Prompt Shaping Processing

Processing of generating a bounding box prompt, more specifically, processing of specifying a bounding rectangle of a plurality of points obtained by the sampling processing described above and expressing a prompt using the specified bounding rectangle; Processing of generating a point prompt, more specifically, processing of directly using, as a prompt, one or a plurality of points obtained by the sampling processing described above; Processing of generating a mask prompt, more specifically, processing of generating a mask using one or a plurality of points obtained by the sampling processing described above and expressing a prompt using the generated mask; and Processing of generating a language prompt, more specifically, processing of generating a prompt expressing, by language, a region indicated by one or a plurality of points obtained by the sampling processing described above.

### Loss Calculation Unit 13

The loss calculation unit 13 calculates a loss with reference to the first region of interest and the second region of interest. For example, the loss calculation unit 13 calculates the loss using a loss function configured in such a way that a value of the loss is made smaller as a degree of difference between the first region of interest and the second region of interest is smaller. The loss function referred to by the loss calculation unit 13 may also include a reconstruction loss indicating a difference between the target image TI and the reconstructed image RE. A more specific example of the loss function referred to by the loss calculation unit 13 will be described later.

### Training Unit 14

The training unit 14 trains the first generation unit 11 with reference to the loss calculated by the loss calculation unit 13. For example, the training unit 14 updates parameters of at least one of the encoder used by the object representation extraction unit 112, the extraction model used by the object representation extraction unit 112, and the decoder included in the reconstruction unit 121 with reference to the loss calculated by the loss calculation unit 13. For example, the training unit 14 updates those parameters in such a way that the loss calculated by the loss calculation unit 13 is made smaller.

### Output Information Generation Unit 15

The output information generation unit 15 generates output information including information generated (extracted) by the control unit 10, and outputs the generated output information to the outside via the communication unit 30 or the input/output unit 40. For example, the output information generation unit 15 may generate output information including the object representation extracted by the object representation extraction unit 112, and may supply the output information to the monitoring device 60 via the communication unit 30. The output information may include the reconstructed image RE generated by the reconstruction unit 121, or may include information generated by another configuration included in the control unit 10.

### Specific Configuration Example and Processing Example 1

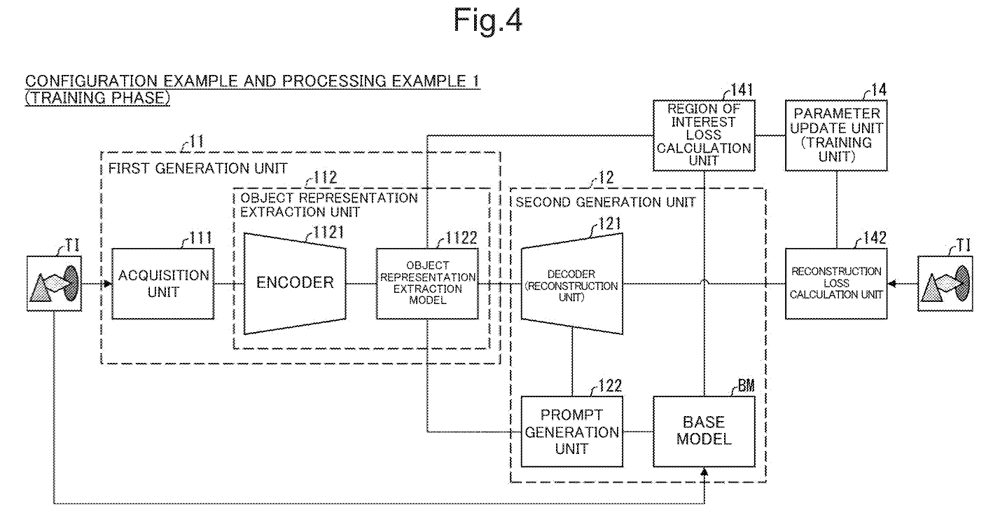

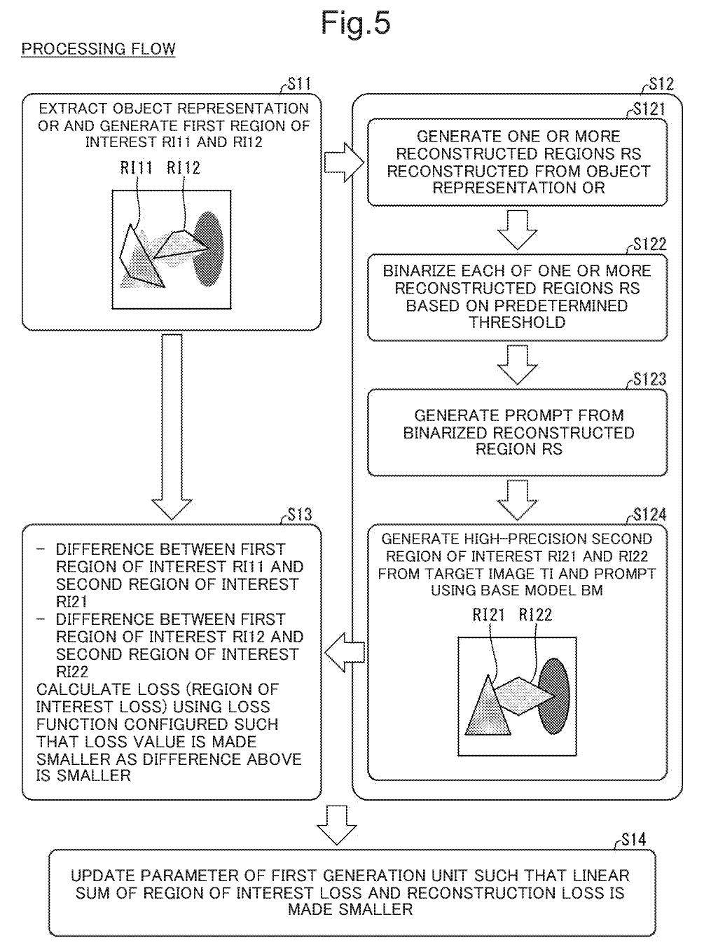

Next, a specific configuration example and a processing example 1 of the information processing apparatus 1A will be described with reference to FIGS. 4 and 5. FIG. 4 is a diagram illustrating the specific configuration example and the processing example 1 of the information processing apparatus 1A in the training phase. FIG. 5 is a diagram schematically illustrating an exemplary processing flow of the information processing apparatus 1A in the training phase.

As illustrated in FIG. 4, first, the target image TI is obtained by the acquisition unit 111 included in the first generation unit 11. The obtained target image TI is input to an encoder 1121 included in the object representation extraction unit 112. Then, an object representation extraction model (extraction model) 1122 extracts one or a plurality of object representations OR with reference to an output of the encoder 1121. The object representation extraction unit 112 generates K (K is a natural number) first region of interest maps (attention masks in this example) based on the one or plurality of object representations OR, and supplies the generated first region of interest maps to the prompt generation unit 122 and to a region of interest loss calculation unit 141.

The one or plurality of object representations OR extracted by the extraction model 1122 are supplied to the decoder (reconstruction unit) 121, and the decoder 121 generates (reconstructs) the reconstructed image RE from the object representations OR.

The target image TI is also supplied to the base model BM, and the second generation unit 12 generates, using the base model BM, K’ (K’ is a natural number) second region of interest maps from the target image TI and the prompt PT, and supplies the generated second region of interest maps to the region of interest loss calculation unit 141.

### Step S11

As illustrated in FIG. 5, in step S11, the target image TI is input to the encoder 1121 of the first generation unit 11. Then, the object representation extraction model 1122 of the first generation unit 11 extracts the one or plurality of (K) object representations OR with reference to the output of the encoder 1121. FIG. 5 schematically illustrates first regions of interest RI11 and RI12 indicated by the first region of interest map (attention mask) generated by the first generation unit 11 in this step.

### Step S12

Step S12 in FIG. 5 includes step S121 for generating one or a plurality of reconstructed regions RS reconstructed from the object representation OR, step S122 for binarizing each of the one or plurality of reconstructed regions RS based on a predetermined threshold, step S123 for generating the prompt PT from the binarized reconstructed region, and step S124 for generating high-precision second regions of interest RI21 and RI22 from the target image TI and the prompt PT using the base model BM.

### Step S121

In step S121, the reconstruction unit (decoder) 121 generates the one or plurality of (K) reconstructed regions RS (decoder masks) reconstructed from the object representation OR. For example, K (K is a natural number) reconstructed region maps (decoder masks in this example) are generated with reference to the K object representations OR extracted by the object representation extraction unit 112 in step S11.

### Step S122

In step S122, each of the one or plurality of reconstructed regions RS, which has been reconstructed, is binarized based on the predetermined threshold. For example, each of the K (K is a natural number) reconstructed region maps generated in step S121 is binarized based on the predetermined threshold.

(Step S123) In step S123, the prompt PT is generated from the binarized reconstructed region. For example, a rectangular prompt of the K (K is a natural number) reconstructed region maps binarized in step S122 is generated.

### Step S124

In step S124, the high-precision second regions of interest RI21 and RI22 are generated from the target image TI and the prompt PT using the base model BM.

### Step S13

Then, in step S13, the region of interest loss calculation unit 141 illustrated in FIG. 4 calculates the loss with reference to the first region of interest and the second region of interest. For example, as illustrated in step S13 in FIG. 5, the loss calculation unit 13 calculates the loss (region of interest loss) using the loss function configured in such a way that the value of the loss is made smaller as a difference between the first region of interest RI11 and the second region of interest RI21 and a difference between the first region of interest RI12 and the second region of interest RI22 are smaller. For example, an L2 norm may be used as the loss function. The region of interest loss calculated by the region of interest loss calculation unit 141 is supplied to a parameter update unit (training unit) 14.

### Step S14

Then, in step S14, the training unit 14 trains the extraction model with reference to the loss calculated in step S13. For example, the training unit 14 calculates the reconstruction loss indicating the difference between the target image TI and the reconstructed image RE, and updates the parameters of at least one of the encoder used by the object representation extraction unit 112, the extraction model used by the object representation extraction unit 112, and the decoder included in the reconstruction unit 121 in such a way that a linear sum of the region of interest loss calculated in step S13 and the reconstruction loss calculated in this step is made smaller.

Then, the training unit 14 determines convergence of the parameters with reference to the updated parameters, terminates the training process if the convergence is determined, and returns to step S11 to repeat the training processing if the convergence is not determined.

A model trained in advance may be used as at least one of the encoder used by the object representation extraction unit 112, the extraction model used by the object representation extraction unit 112, and the decoder included in the reconstruction unit 121. In such a case, the training unit 14 trains those models trained in advance according to the processing described above.

While the region of interest indicated by the attention mask is used as the first region of interest in the example described above, it is not limited thereto. The region of interest indicated by the decoder mask may be used as the first region of interest to perform the training processing described above. As described above, in the present example, any of the following processing may be executed: processing of training each model of the object representation extraction unit 112 using the region of interest indicated by the attention mask as the first region of interest; processing of training the decoder included in the reconstruction unit 121 using the region of interest indicated by the attention mask as the first region of interest; processing of training each model of the object representation extraction unit 112 using the region of interest indicated by the decoder mask as the first region of interest; and processing of training the decoder included in the reconstruction unit 121 using the region of interest indicated by the decoder mask as the first region of interest.

### Specific Configuration Example and Processing Example 2

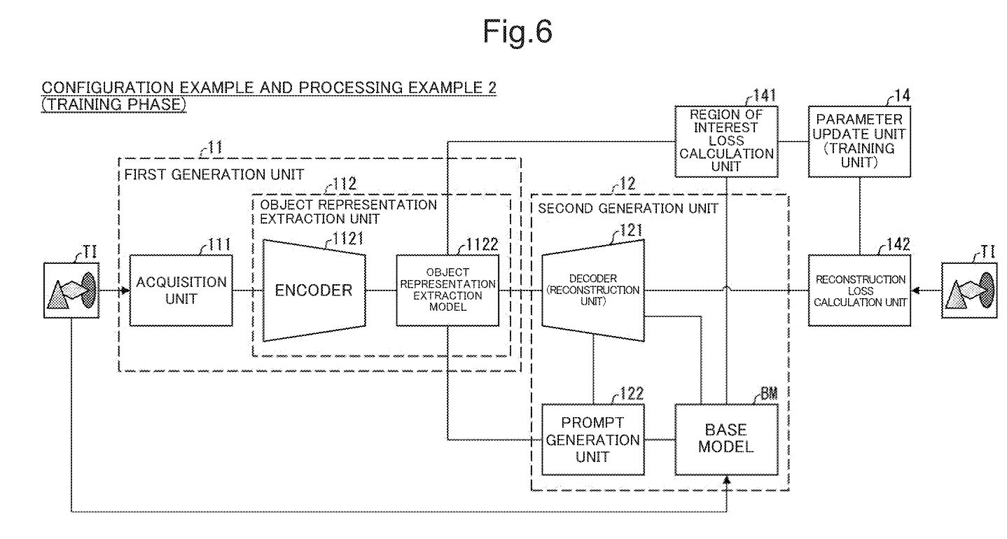

Next, a specific configuration example and a processing example 2 of the information processing apparatus 1A will be described with reference to FIG. 6. FIG. 6 is a diagram illustrating the specific configuration example and the processing example 2 of the information processing apparatus 1A in the training phase.

As illustrated in FIG. 6, in this example, the decoder (reconstruction unit) 121 supplies the reconstructed image RE reconstructed from the object representation OR to the base model BM. Meanwhile, in this example, the target image TI is not supplied to the base model BM. Other processing steps are similar to those of the configuration example and the processing example 1 described above, and thus redundant descriptions thereof will be omitted. According to the configuration described above, it becomes possible to divide the second region of interest highly accurately using the extraction model trained using the knowledge of the base model BM trained in advance.

### Specific Configuration Example and Processing Example 3

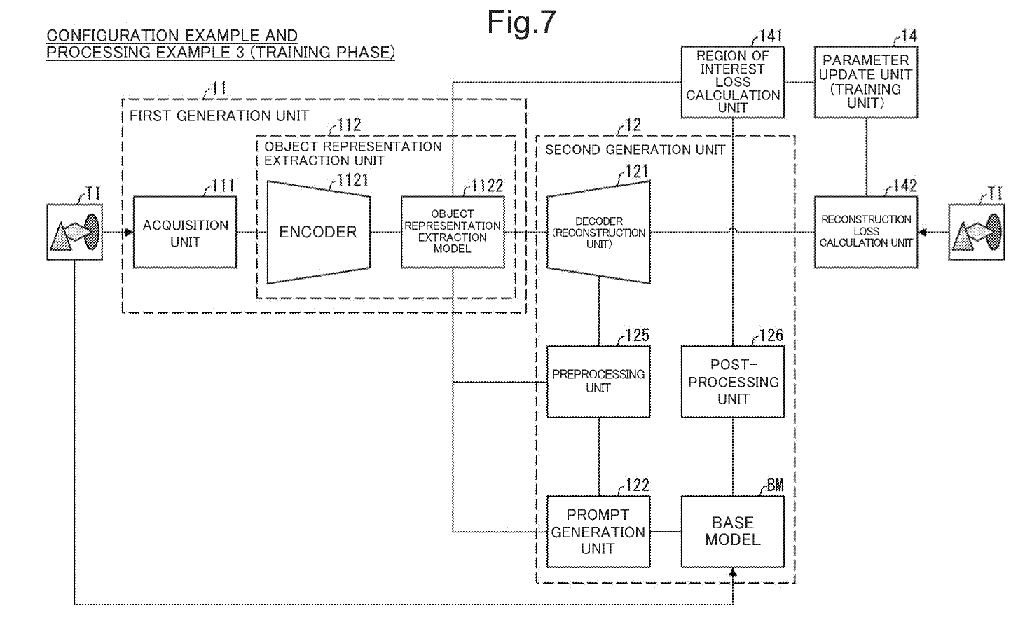

Next, a specific configuration example and a processing example 3 of the information processing apparatus 1A will be described with reference to FIG. 7. FIG. 7 is a diagram illustrating the specific configuration example and the processing example 3 of the information processing apparatus 1A in the training phase.

As illustrated in FIG. 7, in this example, the second generation unit 12 includes the decoder (reconstruction unit) 121, the prompt generation unit 122, a preprocessing unit 125, a post-processing unit 126, and the base model. In this processing example, only one of the preprocessing unit 125 and the post-processing unit 126 may be provided.

The preprocessing unit 125 applies preprocessing to the first region of interest RI1 (attention mask) generated by the object representation extraction unit 112 or the reconstructed region RS (reconstructed region map, decoder mask) generated by the reconstruction unit 121, and supplies the preprocessed data to the prompt generation unit 122. For example, the preprocessing unit 125 applies the preprocessing to the attention mask or the decoder mask in such a way that each mask (region of interest) for each object representation (slot) OR is exclusive, and supplies the preprocessed attention mask or decoder mask to the prompt generation unit 122. For example, the preprocessing unit 125 may execute the processing described above with reference to a score (α coefficient) of the attention mask or decoder mask. As described above, processing dependent on a state of another slot is executed as the preprocessing of the slot, whereby the region of interest regarding each slot (object representation) may be more suitably generated.

The post-processing unit 126 applies post-processing to the second region of interest generated by the base model BM, and supplies the post-processed data to the region of interest loss calculation unit 141. For example, the post-processing unit 126 may execute, as the post-processing, processing of shaping the second region of interest generated by the base model BM into a desired shape.

Alternatively, for example, the post-processing unit 126 applies the post-processing to the second region of interest in such a way that each mask (region of interest) for each object representation (slot) OR is exclusive, and supplies the post-processed second region of interest to the region of interest loss calculation unit 141. For example, post-processing unit 126 may execute the preprocessing described above with reference to a score (α coefficient) of the second region of interest. Alternatively, the post-processing unit 126 may execute the post-processing described above with reference to a score (α coefficient) of the attention mask or decoder mask. As described above, processing dependent on a state of another slot is executed as the post-processing, whereby the region of interest regarding each slot (object representation) may be more suitably generated.

Other processing steps are similar to those of the configuration example and the processing example 1 described above, and thus redundant descriptions thereof will be omitted. Also with the configuration of the present example, it becomes possible to generate a high-precision model by dividing the second region of interest highly accurately and training a model for extracting the object representation.

### Specific Configuration Example and Processing Example 4

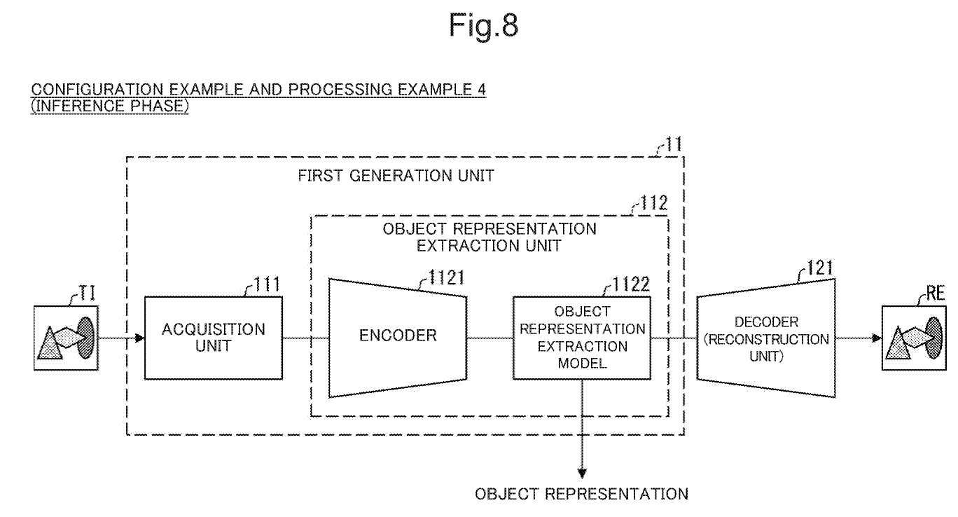

Next, a specific configuration example and a processing example 4 of the information processing apparatus 1A will be described with reference to FIG. 8. This example is a specific configuration example and a processing example of the information processing apparatus 1A in the inference phase. FIG. 8 is a diagram illustrating the specific configuration example and the processing example of the information processing apparatus 1A according to the present example.

As illustrated in FIG. 8, in the inference phase, first, the target image TI to be subject to inference is obtained by the acquisition unit 111. For example, the target image TI is captured by the cameras 70 illustrated in FIG. 3. However, this does not limit the present example.

The target image TI obtained by the acquisition unit 111 is supplied to the encoder 1121.

Then, the object representation extraction model (extraction model) 1122 trained by any processing of the processing examples 1 to 3 described above extracts one or a plurality of object representations OR with reference to the output of the encoder 1121. For example, the extracted object representation is supplied to the output information generation unit 15, and is included in the output information. The output information including the object representation is supplied to, for example, the monitoring device 60, and is referred to in the monitoring processing. The information output in the inference phase is not limited to the example described above, and the reconstructed image RE generated by the decoder 121 with reference to the object representation may also be included in the output image.

According to the configuration described above, it becomes possible to suitably extract the object representation from the target image TI using the extraction model efficiently trained using the knowledge of the base model BM trained in advance.

### Supplementary Information of Second Illustrative Example Embodiment

The present illustrative example embodiment is not limited to the examples described above. For example, a model trained in advance may be used as at least one of the encoder 1121 and the object representation extraction model (extraction model) 1122. For example, a model trained in advance using large-scale training data may be used as at least one of the encoder 1121 and the object representation extraction model 1122, and the training processing may be carried out by transferring the knowledge of the base model BM as described in the processing examples described above. By starting the training processing from a pre-trained model capable of roughly estimating object regions in this manner, it becomes possible to divide the second region of interest highly accurately and to more efficiently train the model for extracting the object representations.

### Third Example Embodiment

A third illustrative example embodiment, which is an example of the example embodiments of the present disclosure, will be described in detail with reference to the drawings. Components having the same functions as the components described in the illustrative example embodiment described above are denoted by the same reference numerals, and descriptions thereof will be omitted as appropriate. An application range of each technique adopted in the present illustrative example embodiment is not limited to the present illustrative example embodiment.

That is, each technique adopted in the present illustrative example embodiment may also be adopted in another illustrative example embodiment included in the present disclosure as long as no particular technical problem is raised. Techniques illustrated in the drawings referred to for describing the present illustrative example embodiment may also be adopted in another illustrative example embodiment included in the present disclosure as long as no particular technical problem is raised.

### Configuration of Information Processing System 100B

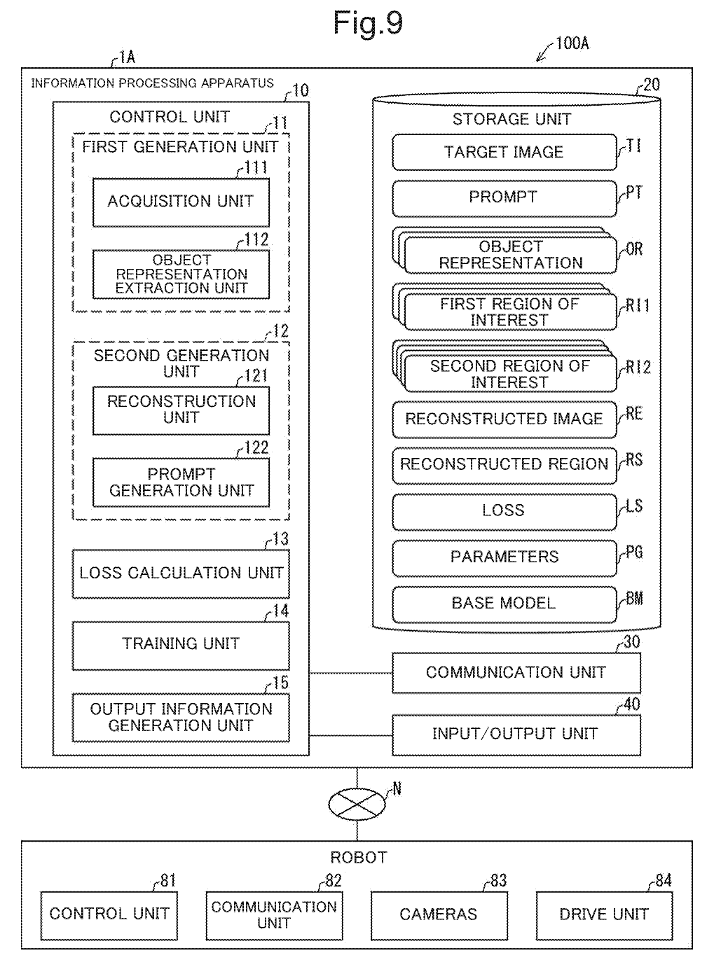

A configuration of an information processing system 100B according to the present illustrative example embodiment will be described with reference to FIG. 9. FIG. 9 is a block diagram illustrating the configuration of the information processing system 100B. As illustrated in FIG. 9, the information processing system 100B includes an information processing apparatus 1A, and a robot 80 connected to the information processing apparatus 1A via a network N. The information processing apparatus 1A and the network N are similar to those in the first illustrative example embodiment, and thus redundant descriptions thereof will be omitted.

### Robot 80

As illustrated in FIG. 9, the robot 80 includes a control unit 81, a communication unit 82, cameras 83, and a drive unit 84. The cameras 83 include one or a plurality of cameras for capturing an area where the robot 80 operates. The drive unit 84 includes a robot arm, a wheel, and the like to be driven under control of the control unit 81.

The communication unit 82 supplies images captured by the cameras 83 to the information processing apparatus 1A via the network N. The communication unit 82 receives object representations extracted from the images from the information processing apparatus 1A via the network N, and supplies them to the control unit 81.

The control unit 81 supplies images obtained by capturing one or a plurality of target objects to the information processing apparatus 1A via the communication unit 82, and controls the drive unit 84 with reference to the object representations extracted from the images by the information processing apparatus 1A. For example, the control unit 81 performs hidden region estimation of the world models, future prediction processing, and the like with reference to the object representations obtained via the communication unit 82, thereby training or planning the control of the robot arm.

### Information Processing Apparatus 1A

As partially described above, in the present illustrative example embodiment, an image captured by the cameras 83 is supplied to the information processing apparatus 1A, and is referred to as a target image TI in at least one of the training phase or the inference phase described in the second illustrative example embodiment.

Then, in the inference phase, the information processing apparatus 1A extracts the object representation from the target image TI by inference processing using the image captured by the cameras 83 as the target image TI. Then, the extracted object representation is supplied to the robot 80, and is referred to for controlling the drive unit 84.

### Exemplary Implementation by Software

Some or all of the functions of the information processing apparatuses 1 and 1A (which will also be referred to as “each of the above apparatuses” hereinafter) may be implemented by hardware such as an integrated circuit (IC chip), or may be implemented by software.

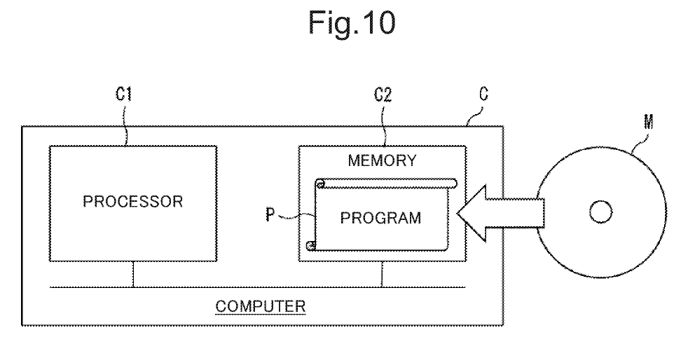

In the latter case, each of the above apparatuses is implemented by, for example, a computer that executes commands of a program, which is software for implementing each function. An example of such a computer (which will be referred to as a computer C hereinafter) is illustrated in FIG. 10. FIG. 10 is a block diagram illustrating a hardware configuration of the computer C that functions as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is implemented.

Available examples of the processor C1 include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Available examples of the memory C2 include a flash memory, a hard disk drive (HDD), a solid state drive (SSD), and a combination thereof.

The computer C may further include a random access memory (RAM) for loading the program P at the time of execution and temporarily storing various types of data. The computer C may further include a communication interface for exchanging data with another device. The computer C may further include an input/output interface for connecting input/output equipment, such as a keyboard, a mouse, a display, a printer, and the like.

The program P may be recorded in a non-transitory tangible recording medium M readable by the computer C. As such a recording medium M, for example, a tape, a disk, a card, a semiconductor memory, a programmable logic circuit, or the like may be used.

The computer C may obtain the program P via such a recording medium M. The program P may be transmitted via a transmission medium. As such a transmission medium, for example, a communication network, a broadcast wave, or the like may be used. The computer C may also obtain the program P via such a transmission medium.

Each of the above functions of each of the above apparatuses may be implemented by a single processor provided in a single computer, may be implemented in cooperation with a plurality of processors provided in a single computer, or may be implemented in cooperation with a plurality of processors provided in each of a plurality of computers. The program for causing each of the above apparatuses to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Note A1

An information processing apparatus including:

a first generation means for extracting an object representation of each of objects included in a target image and generating one or a plurality of first regions of interest based on the object representation;

a second generation means for generating a prompt based on the first region of interest and generating one or a plurality of second regions of interest from the target image and the prompt using a pre-trained model;

a loss calculation means for calculating a loss with reference to the first region of interest and the second region of interest; and

a training means for training the first generation means with reference to the loss.

### Supplementary Note A2

The information processing apparatus according to Supplementary Note A1, in which

the first generation means includes an object representation extraction means for extracting the object representation of each of the objects with reference to the target image,

the second generation means includes a reconstruction means for reconstructing each of the objects with reference to the object representation of each of the objects, and

the training means at least updates a parameter included in the object representation extraction means and the reconstruction means with reference to the loss.

### Supplementary Note A3

The information processing apparatus according to Supplementary Note A2, in which the object representation extraction means generates the first region of interest.

### Supplementary Note A4

The information processing apparatus according to Supplementary Note A2, in which the reconstruction means generates one or a plurality of reconstructed regions reconstructed from the object representation.

### Supplementary Note A5

The information processing apparatus according to Supplementary Note A2, in which the object representation extraction means includes:

an encoder to which the target image is input; and

an extraction model that extracts the object representation of each of the objects with reference to an output of the encoder.

### Supplementary Note A6

The information processing apparatus according to any one of Supplementary Notes A1 to A5, in which

the loss calculated by the loss calculation means is set in such a way that a value of the loss is made smaller as a degree of difference between the first region of interest and the second region of interest is smaller.

### Supplementary Note A7

The information processing apparatus according to any one of Supplementary Notes A1 to A5, in which the second generation means includes:

a binarization means for generating the one or plurality of reconstructed regions binarized with reference to each of the one or plurality of reconstructed regions;

a prompt generation means for generating one or a plurality of the prompts based on each of the one or plurality of reconstructed regions binarized; and

a region of interest estimation means for estimating the one or plurality of second regions of interest from the pre-trained model to which the target image and the prompt are input.

### Supplementary Note A8

The information processing apparatus according to any one of Supplementary Notes A1 to A5, in which

the second generation means estimates the one or plurality of second regions of interest from the pre-trained model to which a reconstructed image reconstructed by the reconstruction means and the prompt are input.

### Supplementary Note A9

An information processing method for causing one or a plurality of processors to perform a process including:

extracting an object representation of each object included in a target image using an extraction model and generating one or a plurality of first regions of interest based on the object representation;

generating a prompt based on the first region of interest and generating one or a plurality of second regions of interest from the target image and the prompt using a pre-trained model;

calculating a loss with reference to the first region of interest and the second region of interest; and

training the extraction model with reference to the loss.

### Supplementary Note A10

A program for causing a computer to function as an information processing apparatus, the program causing the computer to function as:

a first generation means for extracting an object representation of each object included in a target image and generating one or a plurality of first regions of interest based on the object representation;

a second generation means for generating a prompt based on the first region of interest and generating one or a plurality of second regions of interest from the target image and the prompt using a pre-trained model;

a loss calculation means for calculating a loss with reference to the first region of interest and the second region of interest; and

a training means for training the first generation means with reference to the loss.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

According to an exemplary aspect of the present disclosure, an exemplary effect is exerted in which a high-precision model for extracting an object representation may be efficiently generated by training.

1. An information processing apparatus comprising:
one or more memories storing instructions; and
one or more processors configured to execute the instructions to:
extract an object representation of each object included in a target image using an extraction model;
generate one or a plurality of first regions of interest based on the object representation;
generate a prompt based on the first region of interest;
generate one or a plurality of second regions of interest from the target image and the prompt using a pre-trained model;
calculate a loss with reference to the first region of interest and the second region of interest; and
train the extraction model with reference to the loss.

2. The information processing apparatus according to claim 1,
wherein the at least one processor is further configured to execute the instructions to:
extract the object representation of each of the objects with reference to the target image;
reconstruct each of the objects with reference to the object representation of each of the objects; and
update at least a parameter included in the extraction model, an encoder and a decoder with reference to the loss.

3. The information processing apparatus according to claim 2,
wherein the at least one processor is further configured to execute the instructions to:
generate one or a plurality of reconstructed regions reconstructed from the object representation.

4. The information processing apparatus according to claim 2, further comprising: an encoder; and
an extraction model,
wherein the encoder is input the target image, and
the extraction model extracts the object representation of each of the objects with reference to an output of the encoder.

5. The information processing apparatus according to claim 1, wherein
the loss calculated is set in such a way that a value of the loss is made smaller as a degree of difference between the first region of interest and the second region of interest is smaller.

6. The information processing apparatus according to claim 1,
wherein the at least one processor is further configured to execute the instructions to:
generate the one or plurality of reconstructed regions binarized with reference to each of the one or plurality of reconstructed regions;
generate one or a plurality of the prompts based on each of the one or plurality of reconstructed regions binarized; and
estimate the one or plurality of second regions of interest from the pre-trained model to which the target image and the prompt are input.

7. The information processing apparatus according to claim 1,
wherein the at least one processor is further configured to execute the instructions to:
estimate the one or plurality of second regions of interest from the pre-trained model to which a reconstructed image and the prompt are input.

8. An information processing method comprising:
by one or a plurality of processors
extracting an object representation of each object included in a target image using an extraction model and
generating one or a plurality of first regions of interest based on the object representation;
generating a prompt based on the first region of interest;
generating one or a plurality of second regions of interest from the target image and the prompt using a pre-trained model;
calculating a loss with reference to the first region of interest and the second region of interest; and
training the extraction model with reference to the loss.

9. A non-transitory recording medium having stored therein a program for causing a computer to execute:
extracting an object representation of each object included in a target image using an extraction model and
generating one or a plurality of first regions of interest based on the object representation;
generating a prompt based on the first region of interest;
generating one or a plurality of second regions of interest from the target image and the prompt using a pre-trained model;
calculating a loss with reference to the first region of interest and the second region of interest; and
training the extraction model with reference to the loss.
